(19) United States
(12) Patent Application Publication
(10) Pub. No.: US 2024/0344289 A1
(43) Pub. Date: Oct. 17, 2024

(54) SYSTEMS AND METHODS FOR SENSOR ENABLED MONITORING OF WORKING PLATFORMS

(71) Applicant: Tensar International Corporation, Alpharetta, GA (US)

(72) Inventors: John WALLACE, Alpharetta, GA (US); Joseph CAVANAUGH, Alpharetta, GA (US); Matthew HAMMOND, Alpharetta, GA (US); Tom Ross JENKINS, Alpharetta, GA (US)

(73) Assignee: Tensar International Corporation, Alpharetta, GA (US)

(21) Appl. No.: 18/293,589

(22) PCT Filed: Aug. 1, 2022
(86) PCT No.: PCT/US2022/039040

§ 371 Date: Jan. 30, 2024

Related U.S. Application Data
(60) Provisional application No. 63/227,614, filed on Jul. 30, 2021.

(51) Int. Cl. E02D 1/08

(52) U.S. Cl. CPC E02D 1/08; E02D 2600/10

(57) ABSTRACT

Disclosed are various embodiments for a sensor enabled carrier for monitoring and detecting subgrade deformation in working platforms. Working platforms are temporary structures that provide support and stability for heavy machinery (e.g. cranes, piling rigs). They are sometimes referred to as temporary working platforms as they are designed for a specific purpose and a limited lifetime. In one aspect, a sensor enabled carrier is placed within the substructure of a working platform. The sensors are configured to a sensor pod that receives the various inputs, and further transmit the signals to a gateway device. The gateway device may be configured to one or more sensor pods located at the working platform, and serves to transmit the signals to a backend system wherein computing systems interpret the received signals. The backend system may further serve as a distribution point for corrective measures or early warning system in the event subgrade deformation is detected.

### CROSS-REFERENCE TO RELATED APPLICATIONS

This application is related and claims priority to U.S. Provisional Patent Application No. 63/227,614 entitled “Systems and Methods for Sensor Enabled Monitoring of Working Platforms” filed on Jul. 30, 2021. This application is also related to and co-filed with utility application “System and Method for Detecting Subgrade Deformation”, which claims priority to U.S. Provisional Patent Application No. 63/227,626, entitled “System and Method for Detecting Subgrade Deformation. The entire disclosure of said applications are incorporated herein by reference

### FIELD

The present disclosure relates generally to structural health monitoring, more particularly to an application of a sensor enabled carrier and IoT platform for monitoring and detecting changes in the subgrade of working platforms.

### BACKGROUND

Working platforms, or platforms, are temporary structures that provide support and stability for heavy machinery (e.g. cranes, piling rigs, excavators). They are sometimes referred to as temporary working platforms as they are designed for a specific purpose and for a limited lifetime. Most working platforms are utilized at the beginning of construction, or at the onset of a project, and then are later removed as the project advances. A platform will typically consist of aggregate (rock, stone, particulate) over a subgrade (soil), and have a variety of configurations, of which are constructed based on regulatory design parameters and predicted loads. Design parameters typically include factors such as the state of underlying subgrade, bearing capacity, weather conditions, and other geotechnical features.

The application of carriers, such as geogrids, to working platforms allows for an increase in soil performance, and in some applications, reduces the amount of aggregate required to meet design parameters. Geogrids are but one of many applications for improving soil conditions, and collectively may be referred to as carriers herein. At the onset of a working platform design phase, the load parameters and underlying soil (among other parameters—often referred to as design parameters) are used to calculate the thickness of the aggregate and the offset of utilizing geogrid. However, for example, calculating the drilling rig bearing pressure is a complex and often difficult process that may take many parameters, of which may change under geotechnical conditions. For example, bearing pressures will change under different equipment (auger or a hammer) and such design parameters must be calculated to handle all associated equipment for a working platform project.

Subgrade deformation on a working platform can cause irreparable harm and often times may result in a catastrophic loss. The main source of subgrade deformation is a failure to build and develop design parameters to handle bearing pressures. Another source of deformation relates to geological features (hidden and not designed for), including geological unrest, which may occur to weather phenomenon, geotechnical movements, or through time. The aggregate base is designed to provide support and decreases the deformation of the subgrade. The addition of geogrids further increase the stabilization of aggregate, and may also results in a reduction of aggregate thickness requirements.

However, even with proper design parameters, working platforms may be susceptible to subgrade deformation and catastrophic failure due to bearing loads and unforeseen circumstances. The disclosure herein provides systems and methods for applying structural health monitoring through systems and methods of sensor enabled carriers to improve detection of failures within the subgrade of working platforms. Early detection provides an opportunity to prevent catastrophic failures, and correspondingly may save lives, and reduce exposure in construction projects utilizing working platforms.

### SUMMARY

Improvements in methods and systems for monitoring the structural health, integrity, and condition of a subgrade of a working platform is disclosed herein. Such methods employ computing devices, sensors, and carriers to form a sensor fusion of intelligence for delivery on an IoT platform. In one aspect, a system for monitoring and detecting changes in a subgrade of a working platform site is disclosed. In the example, a sensor enabled carrier is comprised of a sensor carrier and one or more sensors configured to the sensor carrier. The system further comprises a sensor pod that is in electrical communication to the one or more sensors on the sensor enabled carrier, along with a gateway device in electrical communication to the sensor pod. The system further comprises a backend computing device equipped with a software program configured to non-transitory memory, the non-transitory memory storing instructions, that when executed by the processing circuitry of the backend computing device, causes the backend computing device to: (1) receive sensor data from the one or more sensors on the sensor enabled carrier; and (2) identify a location within the working platform site of the one or more sensors transmitting data.

In other aspects, a method for monitoring and detecting the condition of a subgrade of a working platform is disclosed. The method begins by installing a sensor enabled carrier into a substructure of a working platform, wherein installing positions the sensor enabled carrier throughout a working dimension of the working platform. Next, installing a sensor pod within the working dimension of the working platform that is in electrical communication with the one or more sensors on the sensor enabled carrier. Then, providing a gateway device that is in electrical communication with the sensor pod. Next, providing a computing device equipped with a software program configured to non-transitory memory, the non-transitory memory storing instructions, that when executed by the processing circuitry of the backend computing device, causes the backend computing device to: (1) receive signals from the sensor enabled carrier: (2) process the signals from the sensor enabled carrier: (3) monitor the processed signals from the sensor enabled carrier; and (4) detect a change in the subgrade based on at least one parameter of the processed signals.

In even further aspects, a method for monitoring subgrade of a working platform is disclosed. The method begins by providing a plurality of sensors configured to a sensor enabled carrier. Then connecting the sensor enabled carrier to a sensor pod, wherein connecting is in electrical communication with one another. Then, connecting the sensor pod to a gateway device, wherein connecting is in electrical communication with one another. Next, transmitting signals from the plurality of sensors to a backend computing system, wherein transmitting is via processing circuitry and communications circuitry on the sensor enabled geogrid. Lastly, executing a monitoring engine on non-transitory memory of a computing device via processing circuitry, wherein the monitoring engine monitors the signals for parameter thresholds.

### BRIEF DESCRIPTION OF DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 is an illustration of an example systems of monitoring and detecting conditions of a working platform;

FIG. 2 is a flow diagram of a sensor enabled carrier system and method for detecting subgrade deformation in a working platform:

FIG. 3 illustrates an example of a sensor based carrier application at a working platform:

FIG. 4 illustrates an example of the geometry of bearing capacity at a working platform;

FIG. 5 illustrates an example of the architecture for a system and method for monitoring subgrade at a working platform:

FIG. 6 illustrates an example configuration of a sensor based carrier, a sensor pod, and gateway in relation to a working platform:

FIG. 7 illustrates an example networking architecture for the system and method for monitoring subgrade at a working platform:

FIG. 8 illustrates an example of edge data collection at a working platform and communication to a computing network:

FIG. 9 illustrates an example embodiment of a plurality of sensors, a sensor enabled carrier, and a sensor pod:

FIG. 10 is a flow chart of an example embodiment of a method for monitoring subgrade at a working platform:

FIG. 11 illustrates an example of a monitoring interface for monitoring subgrade at a working platform:

FIG. 12 illustrates an example calculator for a T-value that may be used in design parameters of a working platform.

### DETAILED DESCRIPTION

The present disclosed subject matter will now be described more fully hereinafter with reference to the accompanying drawings, in which some, but not all embodiments of the disclosed subject matter are shown. Like numbers refer to like elements throughout. The presently disclosed subject matter may be embodied in many different forms and should not be construed as limited to the embodiments set forth herein: rather, these embodiments are provided so that this disclosure will satisfy applicable legal requirements. Indeed, many modifications and other embodiments of the presently disclosed subject matter, as set forth herein, will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Aspects of sensor enabled carrier systems and methods for monitoring and detecting changes in the structural health, integrity, and condition of the substructure (base/subbase and/or sublayers) of working platforms is disclosed. The base/subbase layers typically include aggregate, as well as the soil itself. These layers may be varied depending on the need of the particular working platform. For example, low soil quality may be excavated and replaced with aggregate and better conditioned soil for weight bearing on a working platform.

Sensing technologies, such as a sensor enabled carrier are disclosed (e.g. geogrids, geofabrics, other underground spanning structures that allow for attachment of sensors), wherein the sensor enabled carrier provides data or information from its sensors that can be evaluated to understand the status, condition, or health of the working platform, and to further detect changes in the subgrade as preventative maintenance or alerting of hazardous conditions. This application of sensors to infrastructure is commonly referred to as Structural Health Monitoring (SHM).

Working platforms are uniquely positioned to benefit from utilizing sensors that provide data to evaluate their condition. For example, working platforms are defined by specific dimensions, upon which the heavy machinery may be placed, and of which requires specific design specifications. The working dimension of a working platform is the available space upon which the heavy machinery may be placed or is otherwise geo-technically reinforced (e.g. with a geogrid).

Adding sensors to working platforms has traditionally been difficult due to physical locations (lack of power, lack of communications), the need to design a system that is capable of detecting changes in a subgrade throughout the project timeline, and the need ensure the accurate placement of the sensors to provide meaningful data. These problems are further exacerbated by the conditions and design parameters of working platforms, that is—working within temporary environments, and environments that often lack utilities (e.g. energy, communications networks) and other requirements for traditional monitoring systems.

Accordingly, working platform applications have the potential to benefit from SHM by accumulating active sensor data to assess the conditions affecting the subgrade. For example, in working platforms, overweight or increased bearing weight, erosion, washouts, rutting, or other movements in the platform can occur under the geogrid and aggregate, causing cracks to appear in the surface of the road and eventually (in extreme conditions) catastrophic failure of the working platform. The systems and methods disclosed herein provide for SHM monitoring and enable a safer environment for working platforms.

Currently, design parameters for working platforms utilize the following information:
a. Plant data sheets (dimensions, configurations, weights)
b. Track ground bearing pressures, outrigger or mast foot loads;
c. Ground investigation reports
d. Plan of the working platform and haul roads
e. Topographical survey
f. Existing above and below ground surveys
g. Existing structures survey
h. Constraints on reduced levels
i. Proposed compaction plant/method
j. Duration of use of the platform
k. Any information on existing shallow mining activities or potential voids (i.e. chalk or salt dissolution)
l. General construction traffic and their payloads, including types of lorries, wagons, etc.
m. Any works that may involve excavating through the platform and the planned method of reinstatement.

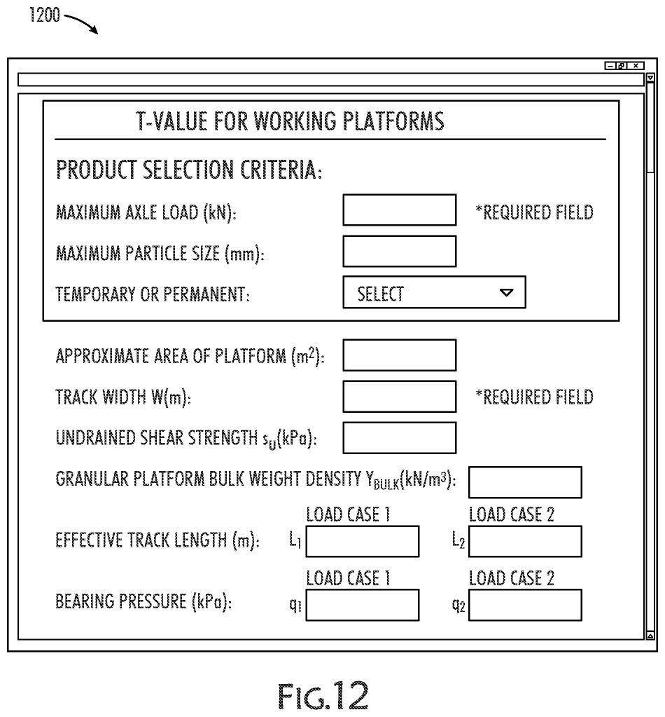

Typically, a geotechnical engineer will design the working platform with the above list in mind, and according to standards that may also involve geosynthetic products such as geogrids and geofabrics. One methodology utilizing geogrids is the T-value (FIG. 12), developed by Tensar Corporation™ that is a calculation of bearing capacity for geo-stabilized granular layer on clay for working platforms. The reference to the T-value is herein incorporated through the following link https://www.tensar.co.uk/tensar-software/T-Value-Calculator (FIG. 12).

Granular layers are often placed over weaker clay soils (subgrade) to improve the bearing capacity of working platforms and to spread the foundation. The installation of geogrid within the granular (aggregate) layer can improve bearing capacity significantly, allowing for thinner granular (aggregate) layers thereby saving project costs and handling fewer materials. The T-value defines the dependency of the two-layer bearing capacity on the shear strength of the two layers.

Additional disclosures herein require an understanding of materials utilized in working platform support and management. Further, how the one or more sensors are embedded or otherwise configured with carriers such as geogrids and geofabrics. The table below highlights the differences in geosynthetic materials. It is important to note that the embodiments herein are not limited to any one type of carrier, as disclosed, the embodiments can be configured, attached, or adapted to a multiplicity of materials, including the substrate and/or underlying soil itself. Furthermore, a combination of materials may be utilized to accomplish the disclosure herein, including examples of layering a sensor enabled carrier with a sensor enabled fabric, or multiple sensor enabled carriers such as geogrids.

Table of Geosynthetics for Working Platforms

| | Polymeric | | Application | Major |
|---|---|---|---|---|
| Geosynthetics | Materials | Structures | Area | Functions |
| Geotextiles | Polypropylene | Flexible, | Retaining | Separation, |
| | (PP), Polyester | permeable | walls, slopes, | reinforcement, |
| | (PET), | fabrics | embankments, | filtration, |
| | Polyethylene | | pavements, | drainage, |
| | (PE), Polyamide | | landfills, | containment |
| | (PA) | | dams | |
| Geogrids | PP, PET, | Mesh-like | Pavements, | Reinforcement, |
| | high | planar product | railway ballasts, | separation |
| | density | formed by | retaining walls, | |
| | polyethylene | intersecting | slopes, | |
| | (HDPE) | elements | embankments, | |
| | | | bridge, | |
| | | | abutments | |
| Geonets | Medium- density | Ney-like planar | Dams, pipeline | Drainage |
| | polyethylene | product with | and drainage | |
| | (MDPE), HDPE | small apertures | facilities | |
| Geomembranes | PE, polyvinyl | Impervious thin | Containment | Fluid |
| | chloride (PVC), | sheets | ponds, | barriers/ |
| | chlorinated | | reservoirs, | liner |
| | polyethylene | | and | |
| | (CPE) | | canals | |
| Geocomposites | Depending on | Combination of | Embankments, | Separation, |
| | geosynthetics | geotextiles and | pavements, | reinforcement, |
| | included | geogrids/ | slopes, | filtration, |
| | | geonets, | landfills, | drainage |
| | | geomembranes | dams | |
| | | and geogrids | | |

Geotextiles also known as geofabrics are one concept highlighted in the table above and in which the disclosure herein may be configured with. There are three ways a geotextile can be manufactured: they are either knitted, woven, and nonwoven or any combination thereof. The distinction between woven and nonwoven is that a woven geotextile is produced by the interlacement of warp and weft yarns. These yarns may either be spun, multifilament, fibrillated, or of slit film. Nonwoven geotextiles are manufactured by mechanically interlocking or thermally bonding the fibers/filaments. The mechanical interlocking is attained through needle-punching.

With regard to function of geotextiles, they operate in several distinct functions and bear similarities to geogrids and geosynthetics. The first being separation, wherein the geotextile provides separation of particles and prevents mixing of substrates and/or underlying soils. Two such issues are fine-grained soils enter the void of the aggregate base and the aggregate punches into the fine grained soil. The first issue is a concern since it avoids adequate drainage and greatly reduces the strength of the aggregate layer which hastens infrastructure failure/erosion. The second issue is a concern because it decreases the effective thickness of the aggregate layer which also hastens road failure and/or increases infrastructure maintenance. The second prominent function of geotextiles is stabilization. The effectiveness of the geotextile stabilization results from two factors. First, the aggregate is compacted above the geotextile and individual stones are configured, which places imprints in the subgrade and geotextile. When configured, aggregates are fixed into a position, which stabilizes the aggregate base layer. The stabilization of the subgrade soil due to geotextile can change the soil failure mode from local shear to general shear. Due to this change in shear, an additional load is permitted before the soil strength is surpassed which allows for a reduced aggregate base layer. A third benefit of geofabrics is reinforcement. The benefits of reinforcement are reliant on the extent of deformation allowable in a given system. Filtration, is an additional function, wherein the defined openings in the geotextile that hold soil particles also allow for and permit fluid movement and flow. The filtration in this aspect filter the soil out, holding it in place while permitting fluids to flow through and egress.

Geogrids are geosynthetics formed with open apertures and grid-like configurations of orthogonal or non-orthogonal ribs. Geogrids are often defined as a geosynthetic material consisting of connected parallel sets of tensile ribs with apertures of sufficient size to allow for strike-through of surrounding soil, stone, or other geotechnical material. Several methods exist for producing geogrids. For example, extruding and drawing sheets of Polyethylene (PE) or Polypropylene (PP) plastic in one or two or even three or more directions, or weaving and knitting Polyester (PET) ribs. Geogrids are designed mainly to satisfy the reinforcement function for a variety of infrastructure, including roads, rail, buildings, ground erosion, and more, however, ancillary benefits such as material cost savings and more are applicable.

Regarding the structure of geogrids, the ribs of a geogrid are defined as either longitudinal or transverse. The direction which is parallel to the direction that geogrid is fabricated on the mechanical loom is known as roll length direction, Machine Direction (MD), or longitudinal direction. On the other hand, the direction which is perpendicular to the mechanical loom and MD in the plane of geogrid, is known as Transverse Direction (TD) or cross machine direction. In other words, the longitudinal ribs are parallel to the manufactured direction (a.k.a. the machine direction); the transverse ribs are perpendicular to the machine direction. Some mechanical properties of geogrid such as tensile modulus and tensile strength are dependent on the direction which geogrid is tested. In a geogrid, the intersection of a longitudinal rib and a transverse rib is known as a junction. Junctions can be created in several ways including weaving or knitting.

Regarding the production of geogrids, geogrids are produced by either welding, extruding, and or weaving material together. Extruded geogrid is produced from a polymer plate which is punched and drawn in either one or more ways. Various aperture types are shaped based on the way the polymer sheet is drawn. Drawing in one, two or three or more directions results in production of uniaxial, biaxial, triaxial, and various other multiaxial geogrids. Polypropylene (PP) or polyester (PET) fibers are generally used to produce woven geogrids. In most cases, these fibers are coated to increase the abrasion resistance of produced geogrid. Manufacturing process of welded geogrid is by welding the joints of extruded polymer woven pieces. Geogrids are also categorized in two main groups based on their rigidity. Geogrids made from polyethylene (PE) or polypropylene (PP) fibers are usually hard and stiff and they have a flexural strength more than 1,000 g-cm. Flexible geogrids, are often made from polyester (PET) fibers by using a textile weaving process. They usually have a flexural strength less than 1,000 g-cm.

While geotextiles can be used for separation, drainage and filtration, or reinforcement, geogrids are mainly used for reinforcement and/or stabilization applications. Geogrids can also provide confinement and partial separation. The confinement is developed through the interlocking mechanism between base course aggregate particles and geogrid openings. The interlocking efficiency depends on base course aggregate particle distribution and the geogrid opening size and aperture. In order to achieve the best interlocking interaction, the ratio of minimum aperture size over D50 should be greater than three. The effectiveness of interlocking depends on the in-plane stiffness of the geogrid and the stability of the geogrid ribs and junctions. The reinforcement mechanisms in geogrid base reinforced infrastructure sections include lateral restraint (confinement), increased bearing capacity and tension membrane effect. Aggregate base layer lateral restraint is the fundamental mechanism for geogrid reinforced infrastructure. For example, a vertical load applied on the surface of the infrastructure would cause lateral spreading motion of the aggregate base materials. As the loading is applied on the surface of the infrastructure, tensile lateral strains are generated in the base layer causing the aggregates to move out away from the loading. Geogrid reinforcement of infrastructure sections restrains these lateral movements, which is known as lateral restraint. In doing so geogrid reinforcement changes the “failure location” from the weaker subgrade soil to the stronger aggregate layer.

Discussing now a series of embodiments. In some embodiments, the presently disclosed sensor-enabled geogrid system and method uses a sensor-enabled geogrid to provide “below the surface” information and/or data about the health, condition, and/or status of working platforms, wherein the “below the surface” information may not otherwise be attainable by conventional means such as by visual inspection. Further, below the surface investigative equipment such as ground penetrating radar, and other instruments require equipment transported to the working platform site and applied in a per occasion basis as well as fitted and designed to work with the parameters of the working platform installation.

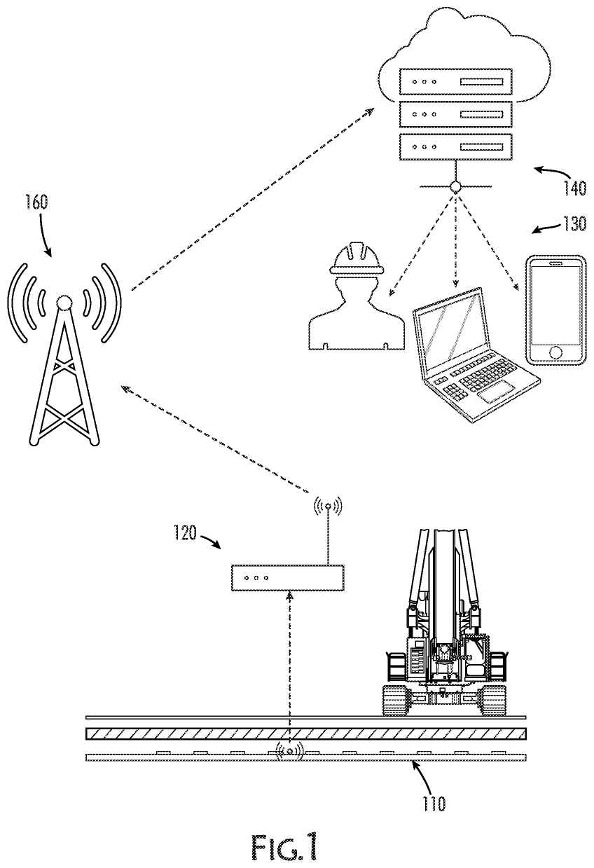

Referring now to FIG. 1, an example IoT platform for the methods and systems disclosed herein. In FIG. 1 a sensor enabled carrier is disclosed, wherein A represents a working platform. The system of infrastructure monitoring comprises a sensor enabled carrier. The sensor enabled carrier is equipped or configured with one or more sensors. The sensor enabled carrier is further configured to a microcontroller, wherein the microcontroller may be stored in or comprised of a sensor pod. The sensor pod provides protection while serving as an edge data collection device. The microcontroller, housed in the sensor pod, is in communication with a gateway device. The gateway device further connects to a computing network, such as a cloud server wherein the received data from the sensor enabled carrier is analyzed and monitored.

In FIG. 1, the sensor enabled carrier 110, such as a geogrid or geofabric, is beneath the aggregate and is in contact with the subgrade of a working platform. In other examples, a sensor enabled carrier may be intermixed with aggregate and subgrade, and the layers may be more or less loosely defined. In the present example, the sensors are placed situationally around the sensor enabled carrier 110, and are often placed within the working dimensions of a working platform. In one aspect, a portion of the sensor enabled carrier may be connected with a flex sensor, wherein as the carrier, such as a geogrid flexes, the signals are interpreted. In this aspect, the flex sensor may be mounted to a member of the carrier, such as a rib or a node, in which the flex may be imputed to the carrier. In other aspects, the sensors may be loosely attached to the carrier, or in other aspects they may be placed at or near the carrier but on strategic members defined to improve readings. For example, a moisture sensor may be placed near the carrier, and thus forming a sensor enabled carrier, wherein the moisture sensor is wired or otherwise configured through a communications module to transmit information to a sensor pod that houses a microcontroller, amongst other things. In some aspects the microcontroller may process data and filter incoming signals from the sensors at the edge, in other aspects the data may be transmitted through a gateway device wherein the computing network may further process the prepare the data for analysis. In this regard, one gateway device may serve one or more sensor pods, and one or more sensors may be served by one sensor pod. In this configuration a sensor swarm is formed, and in the present example, covers the working dimensions of a working platform.

Continuing with FIG. 1, in another aspect, a set of devices or apparatuses for working platform monitoring and detecting is disclosed. In one aspect, an apparatus may include a sensor enabled carrier 110, a sensor pod, a gateway 120 with networking components 160, and a computing network such as a backend computing system 140. In one aspect, the sensor enabled carrier 110 has a plurality of sensors, in others aspects it may only have one sensor configured. In the present example, the sensor pod comprises processing circuitry such as a microcontroller or CPU, a power supply (battery, wired connection), and a communications adapter. The sensor pod and processing circuitry may be further configured to inertial measurement units (IMUs), such as accelerometers, gyroscopes, and magnetometers: as well as a bevy of other sensors such as barometers, strain gauges (electrical and optical), flex sensors (electrical and optical), moisture sensors, ambient light sensors, and temperature sensors. Together, these sensors are operatively configured to a carrier to form a “sensor fusion” or “sensor swarm”, wherein a multitude of sensors are utilized on a sensor enabled carrier to make an inference about an event or condition within the subgrade based on signals derived from the sensors. Sensor fusion has the benefit of reliability as sensor error can be detected and corrected within the sensor network. Further, sensor fusion by its design has redundancy built into the network, providing accurate and reliable readings, even as sensors fail due to physical, mechanical, or electrical wear.

In another aspect, a sensor enabled carrier 110 is equipped with an IMU, such as an accelerometer, wherein the IMU is configured to a member of the carrier, forming a sensor enabled carrier, and placed within subgrade (soil), and then covered with aggregate. The accelerometer within the prepared subgrade may be equipped and configured to have three axes (X, Y, and Z), and may have an initial reading of 1 g or approximately 9.8 m/sec\hat{ }2 in acceleration for orientation. In one example, if the Z axis is pointed directly in line with the gravitational pull or the earth, the X and Y axes would reflect an indication of zero force. In one example, if the Z axis is pointed directly in line with the gravitational pull or the earth, the X and Y axes would reflect an indication of zero force. If a working platform beings to fail, or the Z moves from its origin, the X and Y axes will register a change or a variance from the starting position. By utilizing this detection of change in orientation, a time series or real time model can diagnose and understand conditions as they occur and alert to subsurface deformation within a working platform. Leading to instantaneous feedback as well as improving the overall safety and reliability of working platforms.

Continuing with FIG. 1, the receiver nodes, often referred to herein as a gateway device 120 or node with telecommunications components, receives and transmits information from the sensor pod through a backhaul network or computing network 160, to backend computing systems 140, such as a cloud computing system or data server. Users are positioned at a front end interface to the cloud computing system and may access the system through a mobile application 130, desktop application, or other application that presents information regarding the received signals or information from the sensor enabled carrier. In this example, the sensors are in electrical communication (wired, wireless) to the sensor pod. The sensor pod may receive a plurality of sensor signals through electrical communication. The sensor pod serves as the edge intelligence, and is in electrical communication with the gateway device 120. The gateway device serves a route function, often times receiving electrical communication from a plurality of sensor pods, in some aspects, anywhere from 1-100 sensor pods may electrically transmit (wired, wireless) the observed signals from the one or more sensors connected to each sensor pod. Thus, the sensor pod is an aggregator of signals of the one or more sensors on the sensor enabled carrier. The gateway device is an aggregator of the signals of the one or more sensor pods, and the gateway device serves to transmit the information along a communications network to a backend computing system in which the received signals may be analyzed and processed, and made viewable on an IoT platform.

Continuing, in FIG. 1, one or more sensors are configured with a sensor carrier, such as a geogrid or geofabrics, to form a sensor enabled carrier 110. Such sensors may work with, on, near, or be placed alongside the carrier. The sensors are then placed in electrical communication with a sensor pod that houses processing circuitry and communications circuitry, this often comprises a microcontroller and a communications adapter. The processing circuitry receives, and in some embodiments, filters signals from the various sensors of the sensor enabled carrier. The sensor pod protects and houses edge intelligence, and in some aspects may be weatherproof, crush proof, or water resistant, and may also be in direct or wireless communication with a gateway device through communications circuitry.

In the present example, the sensor pod may also be configured with a battery or coupled to an electrical grid, or a renewable source (PV array, thermal energy conduction). In working platforms, the sensor pod would most often be configured with a battery due to the environment and location. In one aspect, the sensor pod transmits the signals or information from the sensors on or near the sensor enabled carrier to a gateway device 120, the gateway device 120 in turn relays the information through a backhaul network 160 to a backend computing system 140, such as a cloud server. Therein the backend computing system 140 may process metrics and perform computations on the signals derived from the sensors to detect changes in the subgrade of working platforms. For example, it may be determined a maximum strain, flex, or tilt, upon which an alert of erosion may be sent. In this aspect, the one or more sensors measuring strain, flex, or tilt would have a base parameter, and a time series of measurements would indicate a maximum threshold upon which a parameter may reach that would indicate subgrade failure. The parameter may be corrected through algorithmic means, such as for temperature or any other variability, and further the maximum threshold parameter may be relative to the particular sensor, that is each sensor may have some degree of variability with its design specifications that are necessarily imparted to the system. Similarly, a minimum threshold may be designated, in which the system may not raise an alert, this allows for elastic forces to impact the sensor enabled geogrid without causing false alarms. Whereas, inelastic forces, causing irreparable harm to subgrade, would thus trigger an alert under the maximum threshold parameter. Parameters are thus specified by received data, or are variable based on accumulated time series data.

Typical backend computing systems 140 have all the components of a computing device, including processing circuitry (CPU, GPU), memory (transitory, non-transitory), communications circuitry (RF, Wireless, Wired), but may also be configured as a server, such as a cloud server and may be connected through devices which have displays to view the data. Further, backend computing systems may comprise both databases (relational, non-relational) as well as computing interfaces and include the hardware and software to run applications.

Software applications on the backend computing system may develop a time series or time interval data metrics from the sensors, and may also perform additional analytics by incorporating past working platform data. These systems may form the basis for an IoT platform, that allows user devices 130 to connect and process algorithms through the backend computing system. Examples of processing tasks within the IoT platform (software application) include, processing moisture sensor data or weather data over a period of years to determine seasonal variability and impact on subgrade's within a particular geolocation. This empirical research and analytics allow for a deeper understanding and improvement of design parameters and specifications for working platforms. Thus enabling a network of sensing of “under the surface” conditions of a working platform.

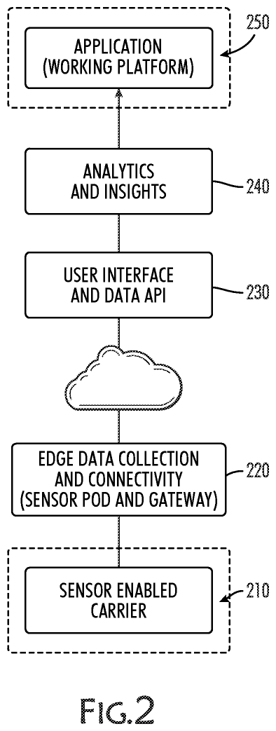

Referring now to FIG. 2, an example flow chart of a method for monitoring and detecting changes in subgrade of a working platform. In one aspect a method for monitoring and detecting subgrade deformation in working platforms is disclosed. The method includes installing/providing a sensor enabled carrier 210 in a substrate material such as a base/subbase and/or subgrade of a working platform. In some examples the sensors configured with the sensor enabled carrier may be spaced at least 5 meters apart, in other configurations they may be 15 meters apart, and in some applications they may be less than 1 meter apart. Such spacing and configuration of the sensors on the sensor enabled carrier, as well as located near the sensor enabled carrier are placed in accordance with design parameters and capability of the sensor, each working platform project is unique and as such placements of sensors may vary without departing from the spirit of this disclosure.

Next, providing a data collection assembly, such as a sensor pod or other data collecting computer 220 (microcontroller, general purpose computer). Then, providing a communication link from the sensor enabled carrier (e.g. via a sensor pod) to a gateway. The gateway then transmitting over a network to a computing device with applicable hardware and software for performing analysis, calculating, computing, diagnosing, and monitoring the data collected by the sensor pod that was transmitted through the gateway. Then monitoring the information in either real time or time series for subgrade deformation at a working platform. In monitoring the information is analyzed and processed with a monitoring engine on processing circuitry, wherein the engine identifies changes in the status of the working platform by analyzing the received signals from the one or more sensors.

Continuing with FIG. 2, the sensor enabled carrier is installed within a subgrade and typically below an aggregate. The sensor enabled carrier serves as a data collection point, wherein one or more sensors gather data about the conditions of the subgrade of a working platform. This is often referred to as edge data collection B, where data is collected at the periphery—a working platform and is transmitted through a gateway and a network connection through to a server or cloud computing environment for applying algorithms and monitoring and detecting changes within the data from the sensor enabled carrier that may give insight into the condition of the subgrade.

The user interface and data application programming interface (API) 230 is often housed on a cloud computing environment such as Microsoft Azure™ or Amazon Web Services (AWS)™ wherein applications 250 or dashboards along with other data API's may be loaded and executed on the signals and information from the sensor enabled carrier. Analytics and insights 240 may be derived from application of algorithms and or viewing collectively the available sensor data and calculating changes over time. For example, if a flex sensor slowly increases in flex, while a similarly located moisture sensor depicts a rise in moisture, the analysis may be that water is traveling into the substrate, causing inelastic deformation (erosion) and as such the working platform may be compromised at a particular location. This may also be the basis for setting the maximum threshold parameter, including relative moisture and flex as requirements. Remedial measures may be ordered or applied in such situations or crews may be warned, thus preventing catastrophic failure.

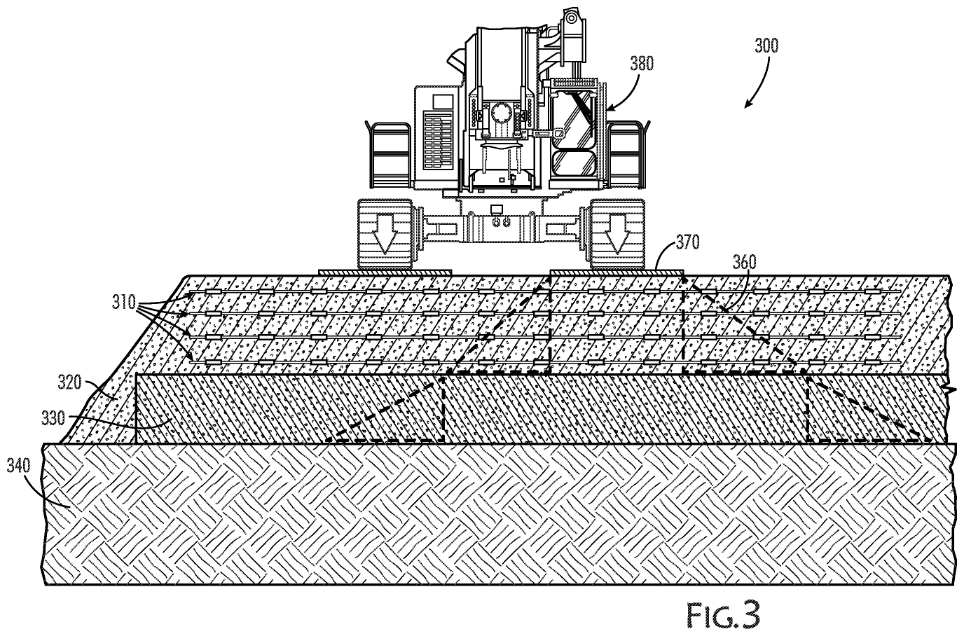

Referring to FIG. 3, an example of a sensor enabled carrier installation at a working platform 300. In the example a piece of heavy machinery 380 (e.g. excavator, tractor, boom lift, pile boring, pile driving) is disclosed above an aggregate layer 320, a cellular mattress 330, and a soft clay substrate 340 (e.g. Su=28 kPa). As disclosed herein, the sensor enabled carrier 310, being a geogrid, allows for reduced loads of aggregate and provides increased bearing capacity. Geogrids, such as those by Tensar Corporation™, can control differential settlement, cap weak deposits, and span voids, amongst other things. For a stabilized layer of a working platform to be effective it must have the ability to distribute load through 360 degrees.

A geogrid enables such distribution by confining aggregate, restraining lateral movement, and trapping particulate within cellulosic layers. In the example, four layers of geogrid are disclosed. In one aspect, each of the four layers maintains sensors. In other aspects only one of the layers. In further aspects, the sensor enabled carrier may be any layer, and may correspond to measure the varying degrees of forces felt on the subbase and/or subgrade. In the present instance the sensor enabled carriers are placed in the subbase layer. In other aspects it may be placed in the subgrade, and in further aspects the layers may not be clearly defined, and are more or less roughly dependent upon the volume of aggregate.

In the example, a hexagonal geogrid is utilized, wherein the hexagonal geogrid may have sensors placed upon it to create a sensor enabled carrier. In other embodiments multiaxial geogrids may be used or geofabrics, wherein on geofabrics the sensors may be knitted or woven or otherwise incorporated. In the present embodiment the sensors may be configured to a sensor pod, also found within the substructure of the working platform, or it may be placed on the periphery. The sensor pod is configured with one or more sensors, of which transmit various signals, data, and information regarding the status or condition of the substructure. The sensor pod is typically configured to a gateway, wherein on or more sensor pods are in communication. The sensor pods may communicate with one another through the gateway or through a series of connections.

Deformations in the soft clay may be detected by strain, flex, and tilt on the sensor enabled carrier, wherein the various sensors may show readings of increased strain/flex/tilt where a deformation is occurring. When a deformation occurs the aggregate will begin to shift in areas that have substrate erosion, creating inelastic wear. Such shifting is what ultimately may give rise to substrate and substructure failure and overall catastrophic failure of the working platform. Early detection and avoidance with the disclosure herein may allow for correcting and repair of a substrate prior to failure.

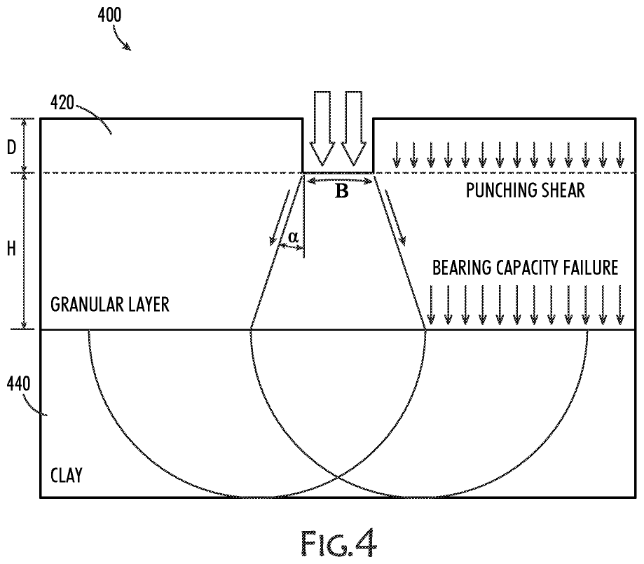

Referring now to FIG. 4, an example of the geometry of bearing capacity at a working platform 400. In the example a net bearing capacity is shown for a working platform. The punching shear discloses the area in which force is distributed from the heaving machinery downward through the aggregate and unto the substrate 420. The uppermost substrate 420 layer is often a prepared layer that may be poured concrete, sand, or aggregate. Depicted as the subgrade layer, the clay layer 440 indicates the overall bearing capacity failure zones, and is an area in which the sensor enabled carrier is designed to detect failure of. Thus this is often referred to as the working dimension of a working platform, or a scope in which a working platform is constructed to maintain and bear the weight of heavy machinery. Continuing, within the granular layer H (aggregate layer), the sensor enabled carrier, as disclosed herein, is placed along with the sensor pods, and serves as structural health monitoring edge intelligence for working platforms.

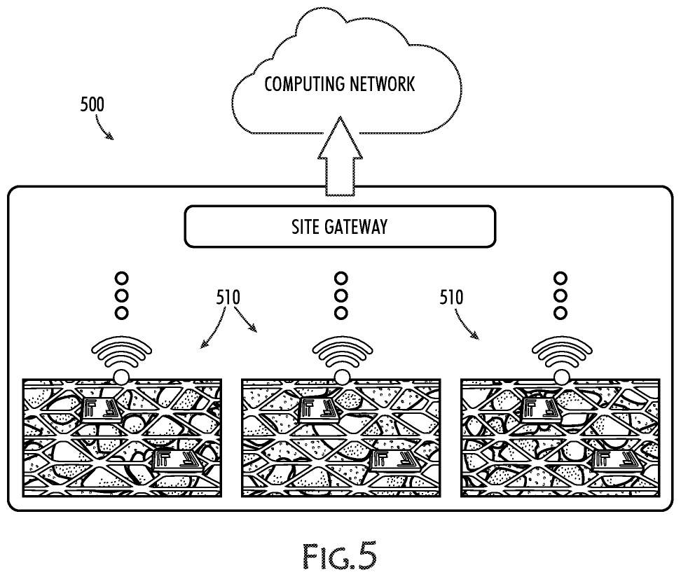

Referring now to FIG. 5, an example of the architecture for a system and method for monitoring subgrade at a working platform 500. The site gateway or gateway device is depicted receiving wireless communications from a plurality of sensor pods 510 within a working platform. The sensor pods 510 are configured with one or more sensors, wherein the sensors are collecting data from the substructure of a working platform. In the disclosed example, the sensor pods are equipped with a radio transmitter that is transmitting the acquired information/signals from the sensors to a gateway. In other aspects, the sensor pods may be wired directly to the gateway device, and in even further examples, there may be a mix of wired and wireless communications between the sensors, the sensor pods, and the gateway devices. The gateway is typically wired to grid power or may be to a battery storage device equipped to a generator, such as a solar generator, gas/diesel generator, or other power generation. The gateway device serves as the router or main communications assembly to a backhaul or computing network. Thus, the gateway device aggregates information from the plurality of sensor pods and channels it to backend computing systems.

In the example the plurality of sensor pods communicates to the gateway and through the gateway with one another. This allows a coordination and in certain aspects increases the “sensitivity” of the readings. Wherein placing additional sensor pods with sensors increases and refines the amount of precision within the readings as it allows a more detailed analysis of the substructure of a working platforms. In some embodiments 10 sensor pods are installed in a working platform, in others 25 sensor pods are installed, in yet other maybe hundreds of sensor pods are installed, depending upon the size of the working platform and conditions present.

The gateway communicates to an IoT platform or a computing network through a communications link from the gateway to the network. The computing network may be a cloud network or a standalone server or other backend systems. Within the computing network may be various data API's and dashboards that may enable new features. Products available on Amazon Web Services include various modules that may be applied to the data within the system and may originate new features and functionality.

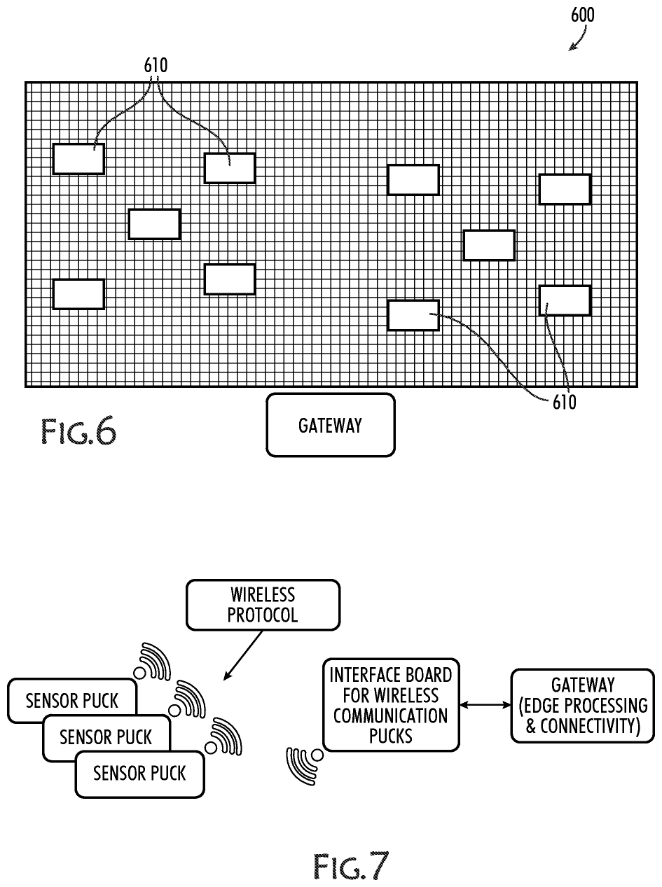

Referring now to FIG. 6, an example of a sensor pod and gateway layout in relation to a working platform 600. Disclosed is a plurality of sensor pods 610 distributed within a working platform. Each of the plurality of sensor pods configured to a sensor enabled carrier bearing a plurality of sensors. The sensor pods are placed in strategic locations wherein the detection by the sensors may indicate changes within the substructure. This placement may be both horizontally or laterally with the addition of more sensor enabled carrier layers. A gateway is disclosed at the periphery of the working platform site, and serves to accumulate the information from the plurality of sensor pods 610 and to distribute it along a communication network to a backend computing system. The system in FIG. 6 is also known as the edge IoT infrastructure, and may further include power sources and other equipment that allow the various apparatus to work. For example, a cellular boosting antennae or array may be available for the gateway when it is placed in a remote environment. Additionally, renewable energy resources may be configured to the equipment, such as a PV array or thermal energy accumulation.

Turning to FIG. 7, an example networking architecture for a system and method for monitoring subgrade at a working platform. In the example, the sensor pods are referred to as sensor pucks, wherein each sensor puck is equipped with a communications circuitry such as a wireless transmission card that transmits signals to a gateway device. In this configuration sensor pucks are distributed uniformly within a substructure at a working platform. The pucks then communicate to an interface board at the gateway device. The gateway device receives the edge data from the sensor pucks and is equipped with a threshold alarm system and a cellular modem to further transmit the signals.

In the disclosure of FIG. 7, an onsite warning system is disclosed wherein the sensor pucks are equipped with wireless communication assemblies and are configured to gather sensor data from an array of sensors. The sensors acquire information about the substructure (subbase and subgrade) of a working platform and are relayed through the sensor pucks to a gateway, wherein the gateway measures the threshold readings and is equipped to alarm if the readings cross a certain threshold. For example, if multiple strain gauges within a close vicinity are experiencing strain past a maximum threshold, the gateway will transmit an alarm such as a noise that will warn the field technicians (geotechnical engineers, contractors, crew) that a catastrophic event may be imminent or that the substructure is failing. This alert applies to any type of sensor that may identify deformation within the subgrade of a working platform.

In further aspects, the gateway device is configured to transmit the acquired data to a computing network where further monitoring and detecting may occur on an IoT platform or through backend processing. The backend computing devices may have algorithms and accumulate data over the length of the project (time series) to better understand the lifetime of working platforms with given design parameters. This time series data allows for interpretation into underlying soils and may further lead to refinement of design parameters within working platforms.

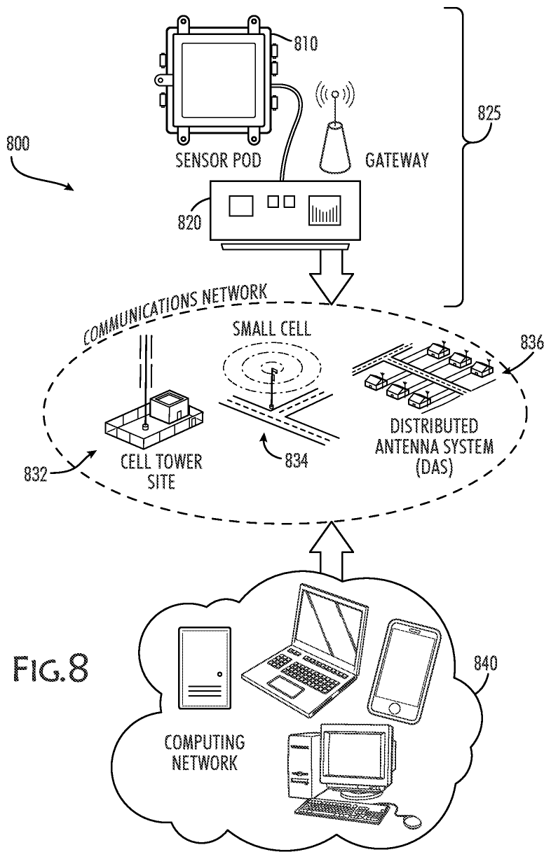

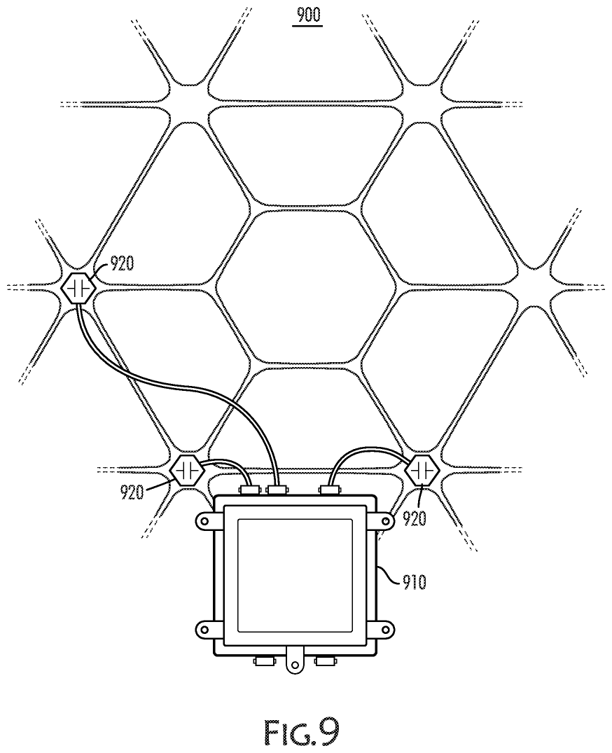

Referring to FIG. 8, an example of a system disclosed herein for edge data collection at a working platform and communication to a computing network 800. Wherein the sensor pod 810 is configured with or connected to (wired or wireless) one or more sensors, such as a flex sensor, strain gauge, accelerometer, gyroscope, moisture sensor, and other sensors as disclosed herein. The edge data collection 825 is configured to transmit the signals and information gathered from the sensor enabled carrier and transmit it through the gateway 820 to the communications network. The communications network may comprise communication networks such as a cell tower site 832 for cellular communications, a small cell 834 for more localized transfer, and a distributed antennae system 836 for additional localized transmission. Other communication networks are available and the listing here is but an example of possible configurations.

In FIG. 8, a gateway 820 may be equipped to the sensor pod 810 which is in further electrical communication with the sensor enabled carrier (not depicted). In one aspect, the gateway 820 is a general purpose computer with processing circuitry and communications circuitry that is configured to receive data from the sensor pod or sensor fusion (in electrical communication with a plurality of sensors), wherein the gateway 820 is equipped to perform computational action on the data and/or to forward the collated or accumulated data through a communications network to a computing network 840, that may include backend systems, personal computing devices, mobile computing devices, etc.

As discussed previously, the gateway and system communication network may be a telecommunications network such as a cellular network, including but not limited to edge, 3G, 4G, 5G, LTE, satellite transmission, radio frequency (RF), microwave transmission, and millimeter wave transmission. Further, the telecommunications network may consist of wireless aspects of WiFi, Wide Area Networks, Bluetooth, long range radio communication (LoRa, LoRaWAN), Near Field Communication (NFC), and the various standards associated therewith such as WiFi 4, WiFi 5, WiFi 6, WiFi 6e, as well as short distance communication protocols with Bluetooth 2.0, 3.0, 4.0, 5.0+, and other such standards as will change or occur from advancements in the field. Further, network communications may also include wired connections such as twisted pair, coaxial, fiber optics, or other such network infrastructure and/or spectrum that will be provided for herein. In one aspect the gateway is equipped with Bluetooth and NFC as well as WiFi and cellular CDMA/GSM standards. The communications network, as common in other IoT platforms, will often travel through a series of steps or interfaces before reaching a computing network that is equipped to process and/or provide an interface for interaction with the data.

The computing network 840 may comprise a variety of devices, wherein users may access the information and develop an understanding of the subgrade and working platform in which the sensor carrier and system is deployed. In this manner, an operator may be at a desktop viewing a dashboard that is configured to display the location and metrics of each sensor. In another aspect a field engineer, such as a geotechnical engineer, may be site side and equipped with a handheld computing device wherein the field technician may be able to diagnose and view real-time the subgrade of a working platform as objects are moved or transported. In further aspects, a pilot or driver of a crane may be able to see real-time or have alerts of the subgrade while in operation, wherein a large load or driving a pylon may show weakening or deformation of the substrate under the heavy machinery and thus alert the pilot of the danger.

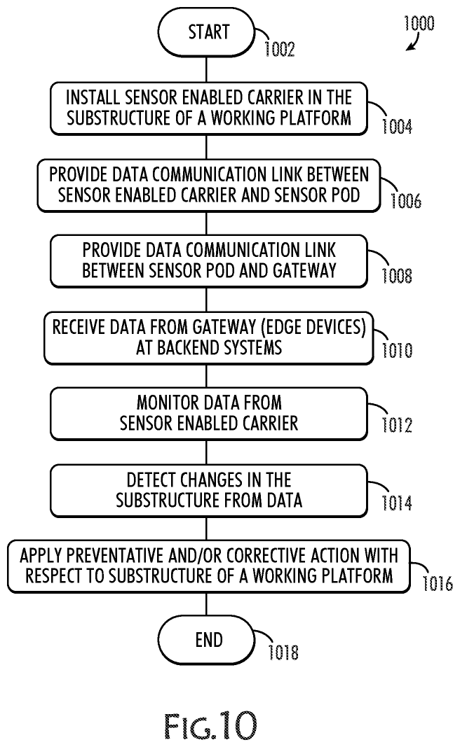

Referring now to FIG. 9, an example of a sensor pod 910 with a microcontroller and a plurality of sensors 920 attached to a multiaxial geogrid 900. In some aspects, microcontrollers can be utilized within the sensor pod 910, or in other cases, a general purpose computing device is housed within the sensor pods protective enclosure. The sensor pod 910 is also configured to receive wired or wireless communications from the various sensors, including gaskets to prevent ingress of water and particulate matter. Further, the computing device within the sensor pod 910 may be attached to an accessory battery pack or an additional module that may be housed in the sensor pod 910 or connected nearby.

In one aspect a microcontroller is configured with a processing unit, cache memory, non-transitory memory (RAM), volatile or non-volatile storage system, and is equipped with a network adapter, and I/O interface. In other embodiments a microcontroller may have built in sensors and/or an array of features such as a timer, accelerometer, and more. Microcontrollers possess several distinct advantages: first, they typically have a low power requirement. Second, they are easy to use, rugged, and come with universal applications. Third, the overall cost and composition is low. Fourth, the interoperability is high—a standard feature set of data RAM, non-volatile ROM, and I/O ports allow for access to a plurality of input devices. Additional benefits of microcontrollers and adaptation of those controllers to the disclosure herein will be known to those of skill in the art.

Continuing in FIG. 9, in another aspect a sensor pod 910 is configured to communicate via a data cable to a gateway (not depicted). Wherein the sensor pod 910 is configured to the sensor enabled carrier, and thus to the plurality of sensors via electrical communication. The sensor pod thereby serves as the recipient of information from the sensor enabled carrier and accumulates data from the various sensors. Often times a plurality of sensor pods will synchronize to form a sensor blanket or sensor fusion, wherein increased detection of deformation at working platforms is capable. In the sensor blanket or sensor fusion network for working platforms, a plurality of sensors may be applied to develop a “fusion” or “swarm” of data input that allows for advanced analytics and a deeper understanding of the subgrade. In this respect one sensor pod may connect to over twenty sensors, and one gateway device may connect to over one hundred sensor pods, as this scales the more granular the information may be from the plurality of sensors.

In a brief example, a moisture sensor paired with a strain gauge may form a sensor fusion with other sensor pods coupled with other sensors. Briefly, strain gauges may be traditional strain gauges with an insulating flexible backing which supports a metallic foil pattern or more advanced strain gauges such as fiber optic strain gauges. In operation, strain gauges detect the amount of deformation which causes electrical resistance, or in the case of fiber optics, the Fiber Bragg Gratings (“FBGs”), which change shape due to the strain/deformation. In one aspect, strain increases the light windows created by the FBG's and thus show strain on the fiber optic strain gauge. Thus, a strain gauge quantifies a load of an object, such as a tire on a geogrid, through the change in output signals versus the signal when the object was under no load. This holds true for both electronic strain gauges and optical strain gauges. The benefits of an optical strain gauge arrangement include the removal of electricity, allowing them to operate in areas with electromagnetic interference. Further, they have a slimmer profile, and can be embedded in many manufacturing and extrusion processes. However, optical strain gauges do suffer from relatively high coefficient of thermal expansion, thus it is often combined with a temperature sensor to correct for and compensate for temperature.

In one example utilizing strain gauges, wherein strain can be positive (tensile strain), or negative (compressive strain) are utilized in monitoring and detecting changes in the subgrade of a working platform. Strain is dimensionless, unless configured in a manner to detect dimension, in practice the magnitude of strain is low and often measured in microstrains (μ∈). Therefore, strain is the amount of deformation of a body due to applied force. More specifically, strain (∈) is defined as the fractional change in length with the following equation:

$$ε = \frac{Δ L}{L} .$$

Another aspect of strain gauges is to clearly define and understand the parameter or sensitivity to strain. This sensitivity is often expressed quantitatively as the gauge factor or GF. We can determine the gauge factor using the following equation:

$$GF = \frac{\frac{Δ R}{R}}{\frac{Δ L}{L}} or ( \frac{Δ R}{R} ) / ϵ .$$

Wherein the gauge factor GF is defined by the ratio of the fractional change in electrical resistance to the fractional change in the length (strain). The above formula is one algorithm that may be applicable when processing to detect deformation within a subgrade of a working platform.

In another example of a sensor configuration at a working platform may be applied to a geogrid to form a sensor enabled carrier is a flex sensor. Flex sensors may be comprised of phenolic substrate resin, conductive ink, and a segmented conductor, they require understanding of the resistance generated when bent. In one example a flat flex sensor measures 25KΩ, when bent at 45° the flex sensor measures 62.5KΩ, and when bent 90° the flex sensor measures 100KΩ. Depending on the flex sensor and its specifications the resistance generated will differ and thus when described or configured herein the variability is to be expected across devices. Thus, a flex sensor equipped to a geogrid is equipped to detect changes in subgrade by measuring the flex over time and over loading and use of the working platform. A flex sensor in combination with other sensors, such as an accelerometer or a moisture sensor leads to a further understanding of “below the surface” conditions and provides metrics and knowledge previously unknown about working platforms and how the subgrade handles varying usage. One goal with the disclosure is to improve design specifications and parameters by accumulating knowledge of subgrade infrastructure through an amalgamation of the various installations, thereby defining design parameters based on previous use case feedback.

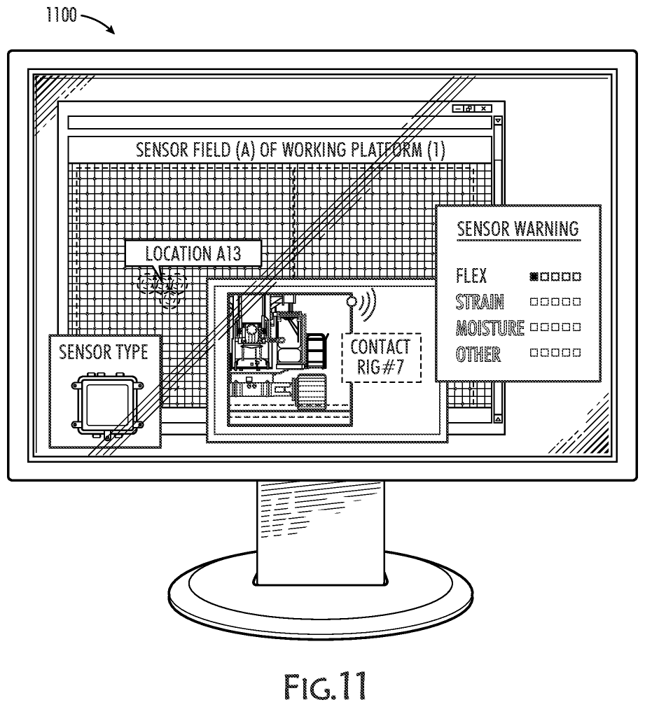

Referring now to FIG. 10, a flow chart of an example embodiment of a method for monitoring subgrade at a working platform 1000. Wherein the method begins with installing a sensor enabled carrier in the substructure of a working platform 1004. This installation also typically occurs with the sensor pod installation, wherein each sensor pod may be marked with a specific serial or reference number. The position of the sensor pod may be indicated on installation, thus defining the specific location of the sensor pod and sensors within the installation at a working platform site. Installation typically occurs by verifying the integrity of the subgrade and adding the multi axial geogrid with sensors and sensor pod to the substructure, marking the serial designation of each within a map or computing system, and filling or replacing with aggregate and developing the foundation for a working platform site. The various stages of grading and aggregate deposition for working platforms are well known, and specifications can be found at http://www.dfi.org/viewpub.asp?tid=TM-PLATFORMS.

Next, providing data communication link between the sensors on or near the sensor enabled carrier and the sensor pod 1006. Wherein the link may be wired or wireless and over a variety of protocols. The sensor pod serves as the “brains” of the edge network, wherein it accumulates the data and information from the one or more sensors, and may even communicate with other sensor pods in an array also known as a sensor fusion or sensor swarm. The sensor pod may be powered by battery, configured to an electrical grid, or other source such as a photo voltaic panel or a thermal energy harvest, to name a few.

Following, is to provide data communication from the sensor pod to the gateway device 1008. Wherein the gateway device services as a point of communication to a broader network and ultimately a computing network wherein the information received by the sensors can be reviewed and interpreted. The connection from the sensor pod to the gateway may be wired or wireless and may transmit through Ethernet or other standards. Often times one gateway will service one or more sensor pods, in this method one gateway may be located at a working platform, wherein multiples of sensor pods may be placed alongside the sensor enabled carrier. Thus forming an array or sensor fusion that communicates to the gateway for transmission to a broader network.

Continuing with FIG. 10, the backend systems (cloud computing environment) receives data or information from the gateway. The gateway transmits information from the one or more sensor pods to the backend systems over a communications network. Next, the backend systems receive the data from the edge devices (sensor enabled carrier, sensor pod, gateway) 1010 and begin to monitor and perform calculations such as applying algorithms to detect changes in flex or strain, or changes within inertial measurement units such as an accelerometer 1012. This may be performed on backend systems utilizing a programming engine within the application or IoT platform. The engine may be set to detect maximum parameters (strain/flex/tilt) within the subgrade of a working platform in which may trigger an alert or other information that may be displayed to users 1014.

Lastly, when changes in the substructure of a working platform are detected the user may alert on site field engineers and either take preventative or corrective measure or secure the area in preparation for substructure failure 1016. In the event the deformation is detected early enough corrective measures may be applied, as the severity of the deformation increases a warning may be sent to the operator of the heavy machinery that a catastrophic failure is imminent if continued bearing pressures are received.

In the example of FIG. 11, the networked computing infrastructure (cloud computing and data API to backend computing systems) may comprise a dashboard that may display a map of installed sensor enabled carrier 1100. This graphical system is designed to indicate, typically through visual interpretation of data, the received signals and status of the working platform site. In one aspect, the IoT platform map or visual aid is a software program such as a dashboard, which may depict sensor locations across the installation on the working platform, thereby developing a sensor fusion or sensor swarm of the working platform. These locations may be entered by serial number at installation, or may be calculated based on relative positioning or through GPS circuitry built into the sensor pod, and configured with the processing and communications circuitry. The software program may run on non-transitory memory and take as input data derived from the sensors on the sensor enabled carrier. One feature of the software program may be to detect deviations from normal (change in subgrade) by monitoring threshold parameters. Threshold parameters may include, for example, a maximum amount of allowable flex on a member of a geogrid, or the maximum amount of strain on a member geogrid, or a max amount of tilt on an accelerometer, or a maximum amount of moisture over a period of time. In other aspects, the dashboard may be converted to an application, wherein geotechnical engineers or users may be able to view the infrastructure from an edge device. In the previous example field technicians and geotechnical engineers can use the sensor enabled carrier and dashboard to visually map out locations for further inspection or repair.

In even further embodiments, the edge devices, (sensor enabled carrier, sensor pod, and gateway) may also have Ethernet or data access cables, wherein a field engineer, technician, or geotechnical engineer may be able to plug directly into the intelligence at a given site, thereby performing remediation processes and visually seeing the performance and not requiring wireless communications. Further, the system may be updated, such as calibration of the sensors through the dashboard and through wired or wireless means.

FIG. 12 illustrates an example calculator for a T-value method that may be used in design parameters for installing the present disclosure at a working platform 1200. The algorithm disclosed in FIG. 12 is one metric that may be used with the system and method disclosed herein to improve the design parameters or working platforms. Further, the T-value method may be utilized to determine the number of sensor pods to install, as well as the amount of sensor enabled carrier to provide accurate and reliable detection for working platforms.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments±100%, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

Therefore, the following is claimed:

1. A system for monitoring and detecting changes in a subgrade of a working platform site, comprising:
a sensor enabled carrier, comprising:
a sensor carrier;
one or more sensors operatively configured to the sensor carrier; and
a sensor pod in electrical communication to the one or more sensors;
a gateway device in electrical communication to the sensor pod;
a backend computing device equipped with a software program configured to non-transitory memory, the non-transitory memory storing instructions, that when executed by the processing circuitry of the backend computing device, causes the backend computing device to:
receive sensor data from the one or more sensors; and
identify a location within the working platform site of each of the one or more sensors transmitting data.

2. The system of claim 1, wherein the working platform site comprises an aggregate layer and a subgrade layer and spans a dimension that occupies heavy machinery.

3. The system of claim 1, wherein the sensor enabled carrier is a sensor enabled geogrid or a sensor enabled geofabric.

4. The system of claim 1, wherein the one or more sensors comprises a flex sensor configured to a member of the sensor enabled carrier so that flex is detected from forces on the sensor enabled carrier.

5. The system of claim 1, wherein the one or more sensors comprises a strain gauge configured to a member of the sensor enabled carrier so that strain is detected from forces on the sensor enabled carrier.

6. The system of claim 1, wherein the one or more sensors comprises an inertial measurement unit (IMU) configured to the sensor enabled carrier so that tilt is detected from forces on the sensor enabled carrier.

7. The system of claim 1, wherein the gateway device is in electrical communication, further comprising the gateway device is in electrical communication to a plurality of sensor pods.

8. The system of claim 1, wherein the software program configured to the non-transitory memory of the backend computing device, the non-transitory memory storing instructions, that when executed by the processing circuitry of the backend computing device, causes the backend computing device to:
receive sensor data from the one or more sensors, through the sensor pod, that indicates a failing of the subgrade; and
alerting users of the failing subgrade, including a location of the failing subgrade.

9. A method for monitoring and detecting changes in subgrade of a working platform, comprising:
installing a sensor enabled carrier into a substructure of a working platform, wherein installing positions the sensor enabled carrier throughout a working dimension of the working platform;
installing a sensor pod within the working dimension of the working platform that is in electrical communication with the one or more sensors on the sensor enabled carrier;
providing a gateway device that is in electrical communication with the sensor pod;
providing a computing device equipped with a software program configured to non-transitory memory, the non-transitory memory storing instructions, that when executed by the processing circuitry of the backend computing device, causes the backend computing device to:
receive signals from the sensor enabled carrier;
process the signals from the sensor enabled carrier;
monitor the processed signals from the sensor enabled carrier; and
detect a change in the subgrade based on at least one parameter of the processed signals;

10. The method of claim 9, wherein the at least one parameter is based on a threshold parameter for maximum flex from a flex sensor configured to the sensor enabled carrier.

11. The method of claim 9, wherein the at least one parameter is based on a threshold parameter for maximum strain from a strain gauge configured to the sensor enabled carrier.

12. The method of claim 9, wherein providing a sensor enabled carrier places at least one sensor every 5 meters in any direction along the sensor enabled carrier to form a sensor fusion within the working dimension of the working platform.

13. The method of claim 9, further comprising repairing the subgrade at the location of detected change.

14. The method of claim 9, further comprising alerting at the gateway device of a detected change in the subgrade based on at least one parameter, wherein alerting is an audible and/or visible signal at the working platform.

15. The method of claim 9, wherein installing the sensor enabled carrier utilizes a T-value method.

16. A method for monitoring subgrade of a working platform, comprising:
providing a plurality of sensors configured to a sensor enabled carrier;
connecting the sensor enabled carrier to a sensor pod, wherein connecting is in electrical communication with one another;
connecting the sensor pod to a gateway device, wherein connecting is in electrical communication with one another;
transmitting signals from the plurality of sensors to a backend computing system, wherein transmitting is via processing circuitry and communications circuitry on the sensor enabled geogrid;
executing a monitoring engine on non-transitory memory of a computing device via processing circuitry, wherein the monitoring engine monitors the signals for parameter thresholds.

17. The method of claim 16, wherein the parameter thresholds is based on at least a threshold parameter for maximum strain from a strain gauge configured to the sensor enabled carrier.

18. The method of claim 16, wherein the parameter thresholds is based on at least a threshold parameter for maximum flex from a flex sensor configured to the sensor enabled carrier.

19. The method of claim 16, wherein the parameter thresholds is based on at least a threshold parameter for maximum tilt from an IMU configured to the sensor enabled carrier.
